(19) United States
(12) Patent Application Publication
(10) Pub. No.: US 2014/0316539 A1
(43) Pub. Date: Oct. 23, 2014

(54) DRIVERS AND CONTROLLERS

(71) Applicants: Raju C. Bopardikar, Longmont, CO (US); Douglas L. Voigt, Boise, ID (US); Dwight L. Barron, Houston, TX (US); Paul L. Perez, Los Gatos, CA (US)

(72) Inventors: Raju C. Bopardikar, Longmont, CO (US); Douglas L. Voigt, Boise, ID (US); Dwight L. Barron, Houston, TX (US); Paul L. Perez, Los Gatos, CA (US)

(21) Appl. No.: 14/356,598

(22) PCT Filed: Jan. 31, 2012
(86) PCT No.: PCT/US2012/023396

§ 371 Date: May 6, 2014

(51) Int. Cl. G05B 15/02

(52) U.S. Cl. CPC G05B 15/02
USPC 700/20

(57) ABSTRACT

Disclosed herein is a technique to transfer at least one unfinished operation from one controller to a second controller, if the first controller has ceased.

### BACKGROUND

Disk controllers are circuits that enable a processor to communicate with a data storage resource. Many data storage arrangements today divide and replicate data among multiple physical drives. Multiple physical drives arranged in such a way may be called a redundant array of independent disks (“RAID”). Disk array products may be equipped with a plurality of controllers to provide failover management. Such disk array controllers manage the physical disk drives and present them to a computer as logical units such that applications executing therein may perceive these disk arrays as a single drive. Failure of one controller may trigger a second controller to substitute for the first. This allows such failure to be transparent to an application. The controllers included in a disk array may be designed to be in communication with each other such that a given controller in the disk array is always aware of the state of other controllers therein.

### BRIEF DESCRIPTION OF THE DRAWINGS

FIG. 1 is an example configuration of computer apparatus in accordance with aspects of the disclosure.

FIG. 2 is an example of processes in communication with a storage device in accordance with aspects of the disclosure.

FIG. 3 illustrates a flow diagram in accordance with aspects of the disclosure.

FIG. 4 is a working example of controllers executing in accordance with aspects of the disclosure.

FIG. 5 is a working example of controller failover in accordance with aspects of the disclosure.

### DETAILED DESCRIPTION

As noted above, many disk arrays are equipped with a plurality of controllers designed to manage failover scenarios therein. However, many disk controllers, such as host bus adapter (“HBA”) based controllers, are simple controllers that may be arranged within a computer as a peripheral component interconnect (“PCI”) expansion card or may be built into a motherboard. Such controllers may be designed to execute independently of other controllers such that there is no failover capability therein. All operations initiated after the failure of such a controller may never be executed, which may result in permanent loss of data.

In view of the foregoing, aspects of the present disclosure provide a system and method that determine whether a first controller has ceased execution such that the first controller has stopped implementing operations in a storage resource. In another aspect, if it is determined that the first controller has ceased, a configuration file associated with the first controller may be accessed. The configuration file may enable a second controller to substitute for the first controller. In a further aspect, at least one unfinished operation may be implemented in the storage resource. The aspects, features and advantages of the present disclosure will be appreciated when considered with reference to the following description of examples and accompanying figures. The following description does not limit the application; rather, the scope of the disclosure is defined by the appended claims and equivalents.

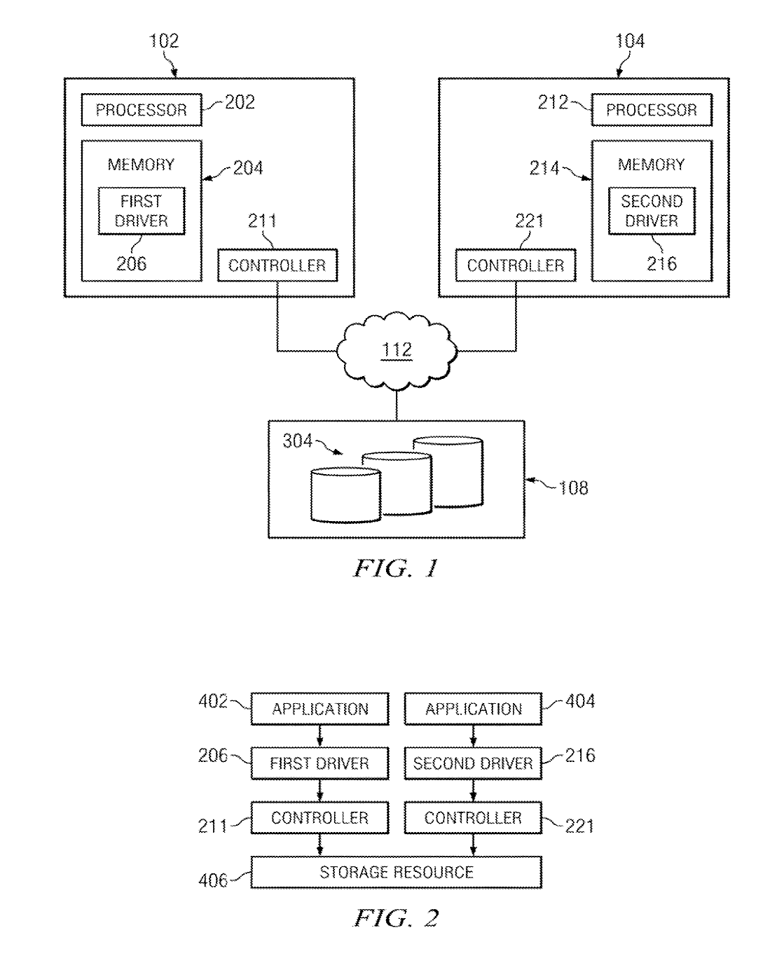

FIG. 1 presents an example of computer apparatus 102 and 104 depicting various components in accordance with aspects of the disclosure. Computers 102 and 104 may comprise any device capable of processing instructions and transmitting data to and from other computers, including a laptop, a full-sized personal computer, a high-end server, or a network computer lacking local storage capability. Computer apparatus 102 and 104 may include all the components normally used in connection with a computer. For example, they may have a keyboard, mouse, and/or various other types of input devices such as pen-inputs, joysticks, buttons, touch screens, etc., as well as a display, which could include, for instance, a CRT, LCD, plasma screen monitor, TV, projector, etc. In another example, they may have a graphics processing unit (“GPU”), redundant power supply, fans, and various input/output cards, such as Peripheral Component Interconnect (“PCI”) cards.

Computer apparatus 102 and 104 may include processors 202 and 212 and memories 204 and 214 respectively. Memories 204 and 214 may store first driver 206 and second driver 216 respectively. First driver 206 and second driver 216 may be retrieved and executed by their respective processors 202 and 212. The processors may be any number of well known processors, such as processors from Intel® Corporation. Alternatively, the processors may be dedicated controllers for executing operations, such as an application specific integrated circuit (“ASIC”). In addition to processors 202 and 212, a remote maintenance processor may be used to monitor components of computer apparatus 102 and 104 for suspect conditions.

Memories 204 and 214 may be volatile random access memory (“RAM”) devices. The memories may be divided into multiple memory segments organized as dual in-line memory modules (“DIMMs”). Alternatively, memories 204 and 214 may comprise other types of devices, such as memory provided on floppy disk drives, tapes, and hard disk drives, or other storage devices that may be coupled to their respective computers directly or indirectly. Memories 204 and 214 may also include non-volatile random access memory (“NVRAM”) devices, which may be any type of NVRAM, such as phase change memory (“PCM”), spin-torque transfer RAM (“STT-RAM”), or programmable permanent memory (e.g., flash memory). The memory may also include any combination of one or more of the foregoing and/or other devices as well. Although all the components of computer apparatus 102 and 104 are functionally illustrated as being within the same block, it will be understood that the components may or may not be stored within the same physical housing. Furthermore, each computer may actually comprise multiple processors and memories working in tandem.

Computer apparatus 102 and 104 of FIG. 1 may be arranged in a networked configuration. For example, each computer may be a node in a cluster of computers and may be capable of directly or indirectly communicating with each other or with other computers or devices in a cluster. While the following examples and illustrations concentrate on communications between computer apparatus 102 and 104, it should be appreciated that a cluster may include additional interconnected computers and that computers 102 and 104 are featured merely for ease of illustration. The computers disclosed in FIG. 1 may be interconnected via a network 112, which may be a local area network (“LAN”), wide area network (“WAN”), the Internet, etc. Network 112 and intervening nodes therein may also use various protocols including virtual private networks, local Ethernet networks, private networks using communication protocols proprietary to one or more companies, cellular and wireless networks, HTTP, and various combinations of the foregoing. In addition, the intervening nodes of network 112 may utilize remote direct memory access (“RDMA”) to exchange information with the memory of another computer in the cluster. It should be appreciated that computer apparatus 102 and 104 may be acknowledged as an individual node in a network containing a larger number of computers. The cluster may be arranged as a load balancing network such that computers 102 and 104 exchange information with each other for the purpose of receiving, processing, and replicating data.

FIG. 1 also shows disk array controllers 211 and 221. Disk array controllers 211 and 221 may be simple HBA based controllers coupled to their respective computers via a host-side interface, such as PCI, Serial ATA (SATA) or serial attached small computer system interface (“SAS”), which allows processors 202 and 212 to transmit one or more input/output requests to disk array 304. Disk controllers 211 and 221 may communicate with disk array 304 via a drive-side interface (e.g., FC, storage area network (“SAS”), etc.). Disk array 304 may be housed in, for example, computer apparatus 108. While FIG. 1 depicts disk array controllers 211 and 221 in communication with disk array 304, it is understood that disk array controllers 211 and 221 may enable a processor to communicate with other storage resources and that FIG. 1 is merely illustrative.

First driver 206 and second driver 216 may comprise any set of machine readable instructions to be executed directly (such as machine code) or indirectly (such as scripts) by the processor(s). The instructions of the drivers may be stored in any computer language or format, such as in object code or modules of source code. The instructions may be stored in object code format for direct processing by a processor, or in any other computer language including scripts or collections of independent source code modules that are interpreted on demand or compiled in advance. However, it will be appreciated that first drivers 206 and second driver 216 may be realized in the form of software, hardware, or a combination of hardware and software.

In one example, first driver 206 or second driver 216 may be realized in any non-transitory computer-readable media for use by or in connection with an instruction execution system such as computer apparatus 102 and 104, an ASIC or other system that can fetch or obtain the logic from non-transitory computer-readable media and execute the instructions contained therein. “Non-transitory computer-readable media” can be any media that can contain, store, or maintain programs and data for use by or in connection with the instruction execution system. Non-transitory computer readable media may comprise any one of many physical media such as, for example, electronic, magnetic, optical, electromagnetic, or semiconductor media. More specific examples of suitable non-transitory computer-readable media include, but are not limited to, a portable magnetic computer diskette such as floppy diskettes or hard drives, a read-only memory (“ROM”), an erasable programmable read-only memory, or a portable compact disc.

First driver 206 may interface processor 202 with controller 211. In turn, controller 211 may interface first driver 206 with disk array 304. Accordingly, first driver 206 may forward data operations, originating from processor 202, to disk array 304 via controller 211. As with first driver 206, second driver 216 may interface processor 212 with controller 221. In turn, controller 221 may interface second driver 216 with disk array 304. The operations forwarded by first driver 206 may be unrelated to the data operations forwarded by second driver 216. First driver 206 may also replicate an operation associated with data, such as an input/output operation, to second driver 216 or vice-versa. While first driver 206 is shown executing in a first domain and second driver 216 is shown executing in a second domain different from the first domain, it is understood that other examples may execute both drivers in the same domain.

FIG. 2 is a high level block diagram depicting an illustrative arrangement of drivers 206 and 216. Applications 402 and 404, which may be local applications or an application from a remote computer, may transmit a request for a data operation, such as an input/output operation, to first driver 206 and second driver 216 respectively. First driver 206 and second driver 216 may abstract the underlying storage resources that are utilized for data operations. Upon receipt of a request for a data operation, such as a write operation, first driver 206 may forward the operation to controller 211. Controller 211 may then forward the same to storage resource 406, which may be disk array 304. Second driver 216 may forward data operations from application 404 to controller 221. As with controller 211, controller 221 may forward the data to the same storage resource 406. Both drivers may also replicate operations to each other at all times so as to maintain redundant copies of data at different locations within storage resource 406. Application 404 may be unrelated to application 402.

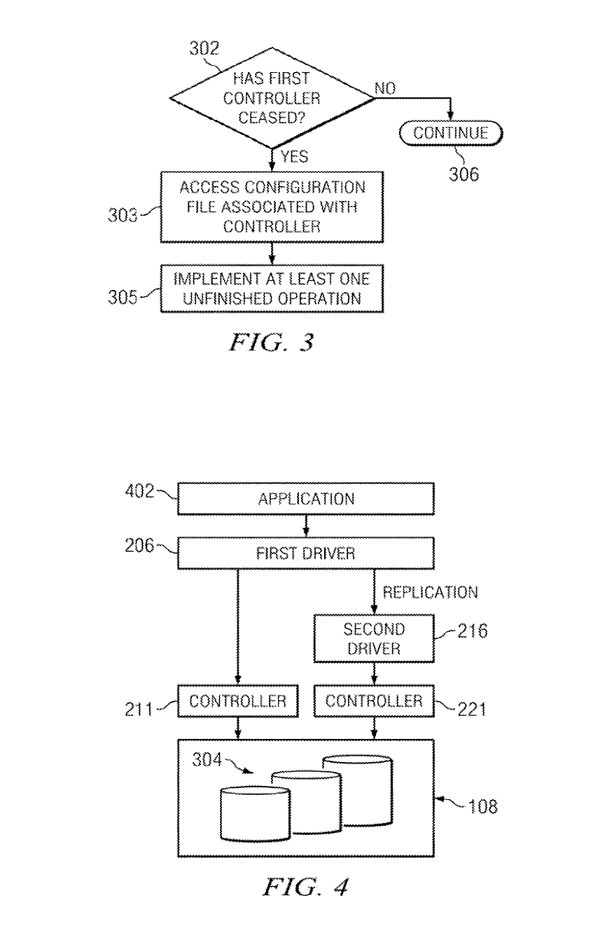

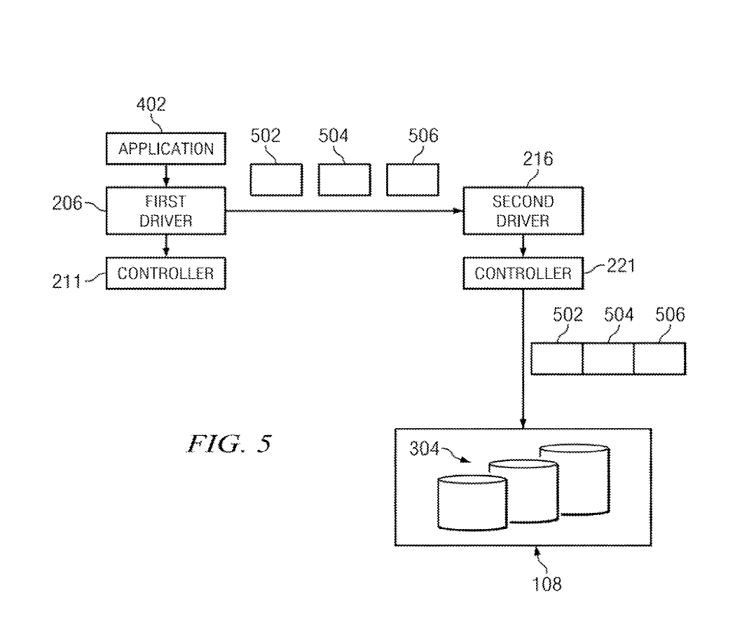

One working example of a system and method for managing controller failovers in accordance with aspects of the present disclosure is shown in FIGS. 3-5. In particular, FIG. 3 illustrates a flow diagram of a process for managing controller failovers. FIGS. 4-5 illustrate various aspects of failover management. The actions shown in FIGS. 4-5, will be discussed below with regard to the flow diagram of FIG. 3.

In block 302, it may be determined whether a first controller has ceased execution such that the first controller has stopped implementing operations in a storage resource. Referring to the example of FIG. 4, controller 211 and first driver 206 are shown functioning normally. In this example, the storage resource is disk array 304 and controllers 211 and 221 are non-redundant disk array controllers. Data operations may be replicated from first driver 206 to second driver 216 during normal operation. First driver 206 may instruct controller 211 to implement operations within selected volumes of disk array 304, while second driver 216 may instruct controller 221 to redundantly implement the same within volumes of disk array 304 that are different than those used by controller 211. Second driver 216 may determine that first controller 211 has failed, when first driver 206 no longer responds to second driver 216. Alternatively, second driver 216 may determine that controller 211 has failed, when there is a lack of communication with controller 211, such as lack of a heartbeat. Referring now to, the example of FIG. 5, controller 211 is shown in a state of failure. The data operations forwarded to first driver 206 by application 402 are shown being replicated to second driver 216 and awaiting execution by second driver 216 via second controller 221. The data operations shown in FIG. 5 are operations 502, 504, and 506.

Referring back to FIG. 3, if the first controller has ceased, a configuration file associated with first controller 211 may be accessed, as shown in block 303. The configuration file may enable controller 221 to substitute for first controller 211. In one example, the configuration file may be stored at a location in disk array 304 such that second driver 216 may upload the configuration file therefrom. The configuration file may contain information that enables controller 221 to implement the unfinished operations in the same location within disk array 304 as first controller 211, such as, for example, the same RAID volumes. The configuration file may include user volumes visible to controller 211, volume worldwide names, or other SCSI configuration data, such as RAID level configuration. Referring back to FIG. 3, at least one unfinished operation may be implemented, as shown in block 305. Referring back to FIG. 5, second driver 216 may obtain the at least one unfinished operation from first driver 206. Second driver 216 may initiate execution of the unfinished operations by forwarding them to controller 221. Having access to the configuration file associated with controller 211 may allow controller 221 to substitute for controller 211. This transfer of control may be transparent to application 402. First driver 206 may continue replicating data operations to second driver 216 while controller 211 is inactive. As noted above, first driver 206 may replicate data to second driver 216 or vice versa at all times notwithstanding the state of controller 211 or controller 221. However, when controller 211 fails, second driver 216 may instruct controller 221 to further implement the replicated operation in the same location in storage used by controller 211. Such location may be specified in the configuration file associated with controller 211. Referring back to FIG. 3, if the first controller has not ceased, the second driver 216 may continue executing as normal, as shown in block 306.

Advantageously, the above-described system and method provides failover capabilities to controllers that may be designed to execute independently, such as inexpensive HBA based controllers. In that regard, users of such controllers may be rest assured that their data will be maintained notwithstanding the failure thereof. In turn, users may have transparent failover management without purchasing expensive enterprise controllers.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein. Rather, various steps can be handled in a different order or simultaneously, and steps may be omitted or added.

1. A system comprising:
a first driver to interface a first processor with a first controller, the first controller interfacing the first driver with a storage resource;
a second driver to interface a second processor with a second controller, the second controller interfacing the second driver with said storage resource, the first controller and the second controller being designed to execute independently of each other, the second driver having instructions therein which, if executed, causes the second processor to:
determine whether the first controller has ceased execution such that the first controller has stopped implementing operations in the storage resource;
if the first controller has ceased, access a configuration file associated with the, first controller, the configuration file enabling the second controller to substitute for the first controller; and
implement at least one unfinished operation in the storage resource.

2. The system of claim 1, wherein the first driver executes in a first domain and the second driver executes in a second domain different than the first domain.

3. The system of claim 1, wherein the storage resource is a redundant array of independent disks.

4. The system of claim 1, wherein the second driver has instructions therein which, if executed, further causes the second processor to retrieve the configuration file associated with the first controller from the storage resource.

5. The system of claim 1, wherein the second driver, if executed, further causes the second processor to initiate the at least one unfinished operation via the second controller.

6. The system of claim 1, wherein the at least one unfinished operation originates from the first processor.

7. The system of claim 6, wherein the second driver, if executed, further causes the second processor to obtain the at least one unfinished operation from the first processor via the first driver.

8. A non-transitory computer readable medium having instructions stored therein which, if executed, causes a processor to:
determine whether a first controller has ceased execution such that the first controller has stopped implementing operations in storage resource;
if the first controller has ceased, access a configuration file associated with the first controller, the configuration file enabling a second controller to substitute for the first controller; and
implement at least one unfinished operation in the storage resource.

9. The non-transitory computer readable medium of claim 8, wherein the storage resource is a redundant array of independent disks.

10. The non-transitory computer readable medium of claim 9, wherein the, instructions, if executed, further causes the processor to retrieve the configuration file associated with the first controller from the storage resource.

11. The non-transitory computer readable medium of claim 10, wherein the instructions, if executed, causes the processor to initiate the at least one unfinished operation via the second controller.

12. The non-transitory computer readable medium of claim 8, wherein the at least one unfinished operation originates from a different processor.

13. The non-transitory computer readable medium of claim 12, wherein the instructions, if executed, further causes the processor to obtain the at least one unfinished operation from the different processor.

14. A method comprising:
determining whether a first controller has ceased execution such that the first controller has stopped implementing operation in a storage resource;
if the first controller has ceased, accessing a configuration file associated with the first controller, the configuration file enabling a second controller to substitute for the first controller, the first container and the second controller being host bus adapter controllers; and
implementing at least one unfinished operation in the storage resource.

15. The method of claim 14, further comprising retrieving the configuration file associated with the first controller from the storage resource.
